(19) United States
(12) Patent Application Publication
(10) Pub. No.: US 2021/0392823 A1
(43) Pub. Date: Dec. 23, 2021

(54) MOBILE TRELLIS, COMPONENTS FOR USE WITH MOBILE TRELLISES, AND HORTICULTURAL ENVIRONMENTS INCORPORATING AT LEAST ONE MOBILE TRELLIS

(71) Applicant: David Fortenbacher, Muskegon, MI (US)

(72) Inventor: David Fortenbacher, Muskegon, MI (US)

(21) Appl. No.: 17/346,224

(22) Filed: Jun. 12, 2021

Related U.S. Application Data
(60) Provisional application No. 63/040,997, filed on Jun. 18, 2020.
(60) Provisional application No. 63/092,353, filed on Oct. 15, 2020.

(51) Int. Cl. A01G 13/04; A01G 9/12

(52) U.S. Cl. CPC A01G 13/043; A01G 7/045; A01G 9/12

(57) ABSTRACT

A mobile trellis may be expandable and/or may include reusable components (i.e., components that are used with a second plant following use of the mobile trellis/component with a first plant). A mobile trellis may be incorporated into a horticultural environment. An expandable mobile trellis may include modular components. A mobile trellis may create a microclimate for an associated plant. A mobile trellis may anticipate changes in an associated horticultural environment based upon an event (e.g., a door opening, a component failure, etc.) and/or the mobile trellis may preemptively alter an “input” to, and/or an “output” from, a horticultural environment based on anticipating a change in the horticultural environment.

### FIELD OF THE INVENTION

The present disclosure generally relates to mobile trellises, components for use with mobile trellises, and horticultural environments incorporating at least one mobile trellis. More particularly, the present disclosure relates to expandable mobile trellises that include modular components.

### BACKGROUND

Horticultural environments are ever evolving. A mobile trellis is needed that meets current horticultural environment desires. A mobile trellis is needed that is adaptable between different horticultural environments. A mobile trellis is needed that includes modular components.

### SUMMARY

A mobile plant micro-climate system may include a trellis having a trellis relocation mechanism. The trellis relocation mechanism may include at least three casters. The system may also include an enclosure. The enclosure may be supported by the trellis. The system may further include an environmental controller configured to control an environment of an interior of the enclosure independent from an environment outside the enclosure. The environmental controller may include a first interior environment sensor input, a first exterior environment sensor input, an enclosure access open indication input, and a first interior environment control output. The environmental control may be configured to alter the first interior environment control output based on the enclosure access open indication input irrespective of a status of the first interior environment sensor input or the first exterior environment sensor. In another embodiment, a mobile plant micro-climate may include a trellis having a trellis relocation mechanism and an enclosure. The enclosure may be supported by the trellis. The system may also include an environmental controller configured to control an environment of an interior of the enclosure independent from an environment outside the enclosure. The environmental controller may include a first interior environment sensor input, an enclosure access open indication input, and a first interior environment control output. The environmental control may be configured to alter the first interior environment control output based on the enclosure access open indication input irrespective of a status of the first interior environment sensor input.

In a further embodiment, a mobile plant micro-climate system may include a trellis having a trellis relocation mechanism. The system may also include an enclosure. The enclosure may be supported by the trellis. The system may further include an environmental control input configured to control an environment of an interior of the enclosure independent from an environment outside the enclosure. The environmental control input may be configured to alter an environment inside the enclosure based on an enclosure access open indication input irrespective of a status of the interior environment of the enclosure.

A mobile trellis may include expandable and/or reusable components. At least one of the components may be used with a second plant following use of the mobile trellis/component with a first plant.

In another embodiment, a mobile trellis may be incorporated into a horticultural environment.

In a further embodiment, an expandable mobile trellis may include modular components.

In yet a further embodiment, a mobile trellis may include an environmental controller configured to create a microclimate for an associated plant.

A mobile trellis may include an environmental controller configured to anticipate changes in an associated horticultural environment based upon an event.

In another embodiment, a mobile trellis may include an environmental controller configured to anticipate changes in an associated horticultural environment based upon at least one of: a door opening or a component failure.

In a further embodiment, a mobile trellis may include an environmental controller configured to preemptively alter an input to, and/or an output from, a horticultural environment based on anticipating a change in the horticultural environment.

### BRIEF DESCRIPTION OF THE FIGURES

FIG. 1A depicts a plurality of example mobile trellises arranged within a horticultural environment;

FIGS. 1B-D depict various views of an example mobile trellis for use within a horticultural environment;

FIGS. 2A-H, J and K depict various views of an example large diameter plenum structure;

FIGS. 3A-H, J and K depict various views of an example small diameter plenum structure;

FIGS. 4A-D depict an example offset plenum structure;

FIGS. 5A-C depict an example riser plenum structure;

FIG. 6 depicts an example large web structure;

FIG. 7 depicts an example small web structure;

FIGS. 8A-F depict various views of an example based structure;

FIGS. 9A and 9B depict an example large lighting structure;

FIGS. 10A and 10B depict an example small lighting structure;

FIG. 11 depicts an example environment controller for a horticultural environment;

FIGS. 12A and 12B depict an example enclosure for a micro-climate;

FIGS. 13A-D depict an example enclosure for a micro-climate; and

FIGS. 14A-D depict an example mobile trellis for use with the example enclosure of FIGS. 13A-D.

### DETAIL DESCRIPTION

Often times, horticulturists are faced with growing as many plants as possible within a given space (e.g., a horticultural environment). In order to access each plant, a walkway may be located between each row of plants. Walkway(s) between rows of plants takes away from plant space within the horticultural environment. In order to access a plant from all sides, a walkway may surround each plant within the horticultural environment. Walkways that surround each plant further takes away from plant space within the horticultural environment.

Mobile trellises 101a of the present disclosure may be incorporated within a horticultural environment, such that each mobile trellis 101a may be automatically and/or manually relocated and/or reoriented to provide access to a perimeter of each associated plant. Thereby, a plurality of mobile trellises 101a may be incorporated within an associated horticultural environment with, for example, a single walkway.

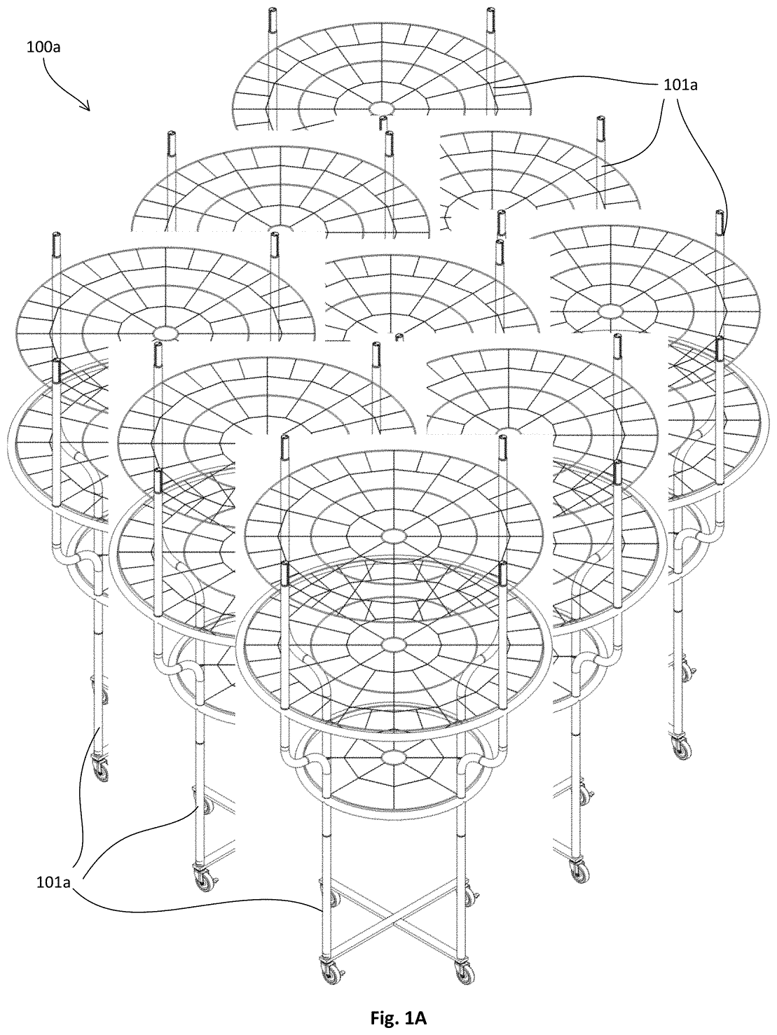

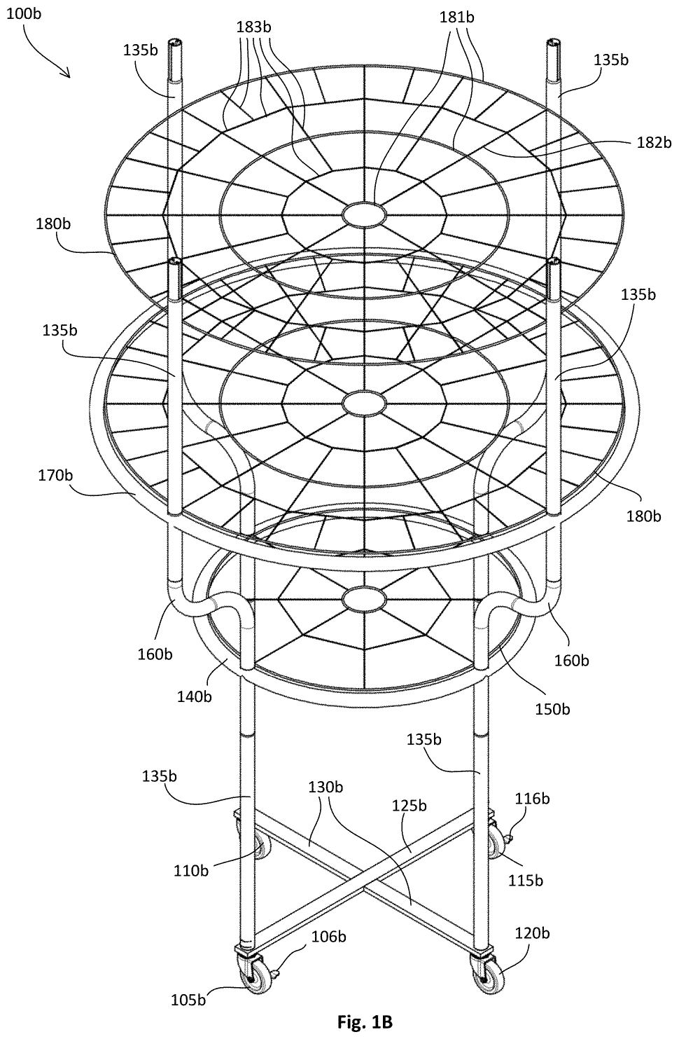

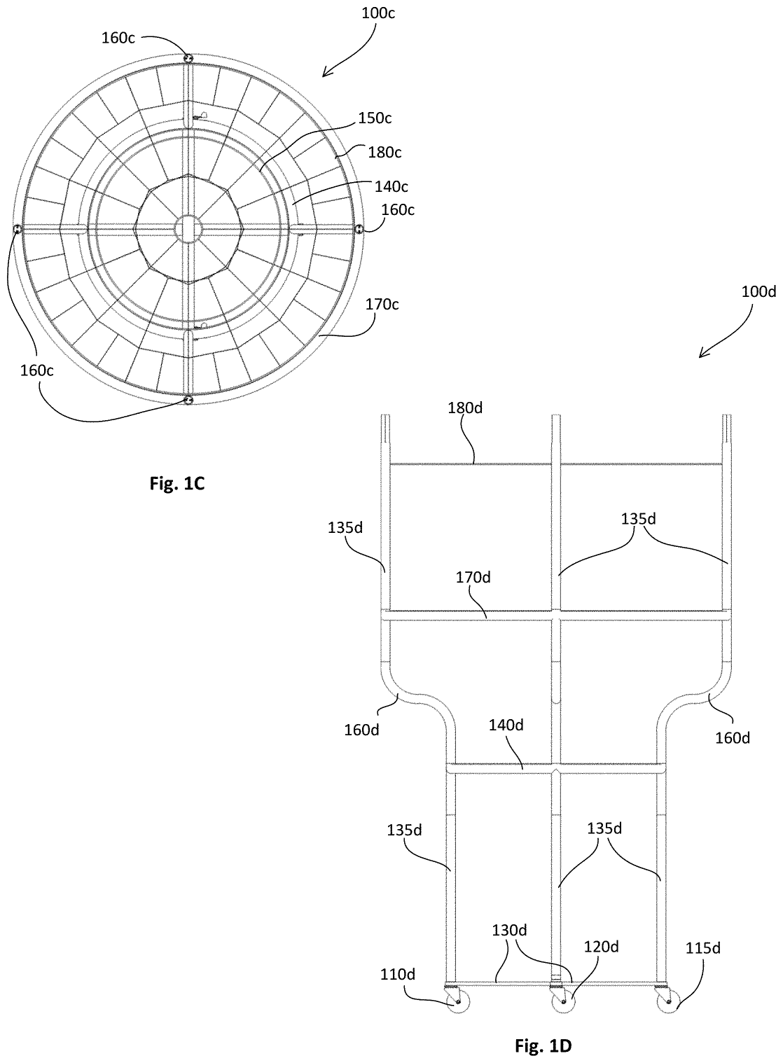

Turning to FIG. 1A, a plurality of mobile trellises 101a may be arranged within a horticultural environment 100a. Any given mobile trellis 101a may include one or more components as described herein. Any given mobile trellis 101a may be configured to support a single plant along with an associated plant root container (e.g., a pot with nutrient rich soil, a bowl with nutrient rich water, etc.). Alternatively, any given mobile trellis 101a may be configured to support a plurality of plants along with an associated plant root container(s). In any event, a plurality of mobile trellises 101a may be incorporated into a horticultural environment.

With additional reference to FIGS. 1B-D, a mobile trellis 100a-d may include a first web 150b,c (e.g., a web with a perimeter defining a circle, a web with a perimeter defining a circle having a 20″ diameter, a web with a perimeter defining a circle having a 24″ diameter, a web with a perimeter defining a circle having between a 10″ diameter and a 25″ diameter, a web with a perimeter defining a square, a web with a perimeter defining a rectangular, a web with a perimeter defining a triangle, etc.) removably supported on a reorientable structure (e.g., long cross-member 125b,c, two short cross-members 130b-d, a first caster 105b with position-lock 106b, a second caster 110b,d, a third caster 115b,d with lock 116b, and a fourth caster 120b,d) via a plurality of vertical extension(s) 135b,d (e.g., four vertical extensions, three vertical extensions, more than four vertical extension, a single vertical extension, an 18″ vertical extension, a 6″ vertical extension, a 12″ vertical extension, a telescopic vertical extension that may extend between 10″ and 20″, etc.). Alternatively, any given mobile trellis 100a-d reorientable structure may include only three casters, or more than four casters. While not shown in FIGS. 1A-D, any given reorientable structure may include a rotary actuator (e.g., an electric motor driven rotary disc, a spindle driven device, etc.). Similarly, any given mobile trellis 100a-d may include at least one motor driven caster. Because, the web 150b,c

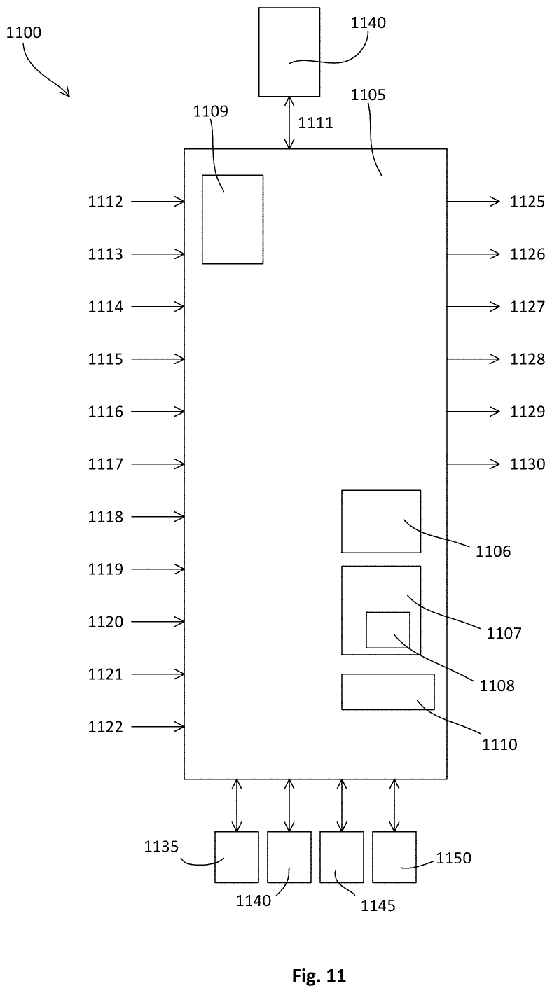

Any given mobile trellis 100a-d may include an HVAC connection (e.g., HVAC interface 1135 of FIG. 11), a liquid connection (e.g., liquid interface 1140 of FIG. 11), a pneumatic connection (e.g., a pneumatic interface 1145 of FIG. 11), an electrical connection (e.g., electrical power/data interface 1150 of FIG. 11), any sub-combination thereof, or a combination thereof. A mobile trellis 100a-d may include a horticultural environment controller (e.g., controller 1105 of FIG. 11). A processor (e.g., processor 1106 of FIG. 11) may execute computer-readable instructions (e.g., module 1108 of FIG. 11) to, for example, cause the processor 1106 to receive at least one input (e.g., an input 1111 from a user interface, at least one input 1112-1122 of FIG. 11, an input from any one of: the HVAC interface 1135, the liquid interface 1140, the pneumatic interface 1145 and/or the electrical power/data interface 1150), and to generate at least one output (e.g., an output 1111 to a user interface, at least one 1125-1130 of FIG. 11, an output to any one of: the HVAC interface 1135, the liquid interface 1140, the pneumatic interface 1145 and/or the electrical power/data interface 1150) based upon the at least one input (e.g., an input 1111 from a user interface, at least one input 1112-1122 of FIG. 11, an input from any one of: the HVAC interface 1135, the liquid interface 1140, the pneumatic interface 1145 and/or the electrical power/data interface 1150). Thereby, a mobile trellis 100a-d may produce a microclimate proximate at least one plant that is supported by the mobile trellis 100a-d.

A mobile trellis 100a-d may include a first weldment structure 140b-d (e.g., a weldment structure with a perimeter defining a circle, a weldment structure with a perimeter defining a circle having a 21″ diameter, a weldment structure with a perimeter defining a circle having a 25″ diameter, a weldment structure with a perimeter defining a circle having between an 11″ diameter and a 26″ diameter, a weldment structure with a perimeter defining a square, a weldment structure with a perimeter defining a rectangular, a weldment structure with a perimeter defining a triangle, etc.) removably supported on a reorientable structure (e.g., long cross-member 125b,c, two short cross-members 130b-d, a first caster 105b with position-lock 106b, a second caster 110b,d, a third caster 115b,d with lock 116b, and a fourth caster 120b,d) via a plurality of vertical extension(s) 135b,d (e.g., four vertical extensions, three vertical extensions, more than four vertical extension, a single vertical extension, an 18″ vertical extension, a vertical extension between 10″ and 25″, etc.). Alternatively, any given mobile trellis 100a-d reorientable structure may include only three casters, or more than four casters. While not shown in FIGS. 1A-D, any given reorientable structure may include a rotary actuator (e.g., an electric motor driven rotary disc, a spindle driven device, etc.). Similarly, any given mobile trellis 100a-d may include at least one motor driven caster. The first weldment structure 140b-d may be configured to support a web 150b,c (e.g., a web with a perimeter defining a circle, a web with a perimeter defining a circle having a 20″ diameter, a web with a perimeter defining a circle having a 24″ diameter, a web with a perimeter defining a circle having between a 10″ diameter and a 25″ diameter, a web with a perimeter defining a square, a web with a perimeter defining a rectangular, a web with a perimeter defining a triangle, etc.).

Any one of: the vertical extension 135b,d, the first weldment structure 140b-d, the first web 150b,c, a sub-combination thereof, or a combination thereof may be configured as a plenum to convey HVAC, liquid, pneumatic, electrical power/data from a respective source to the mobile trellis 100a-d. While not shown in FIGS. 1A-D, anyone of: a vertical extension 135b,d, the first weldment structure 140b-d, the first web 150b,c, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

A mobile trellis 100a-d may include a set of offset posts 160b,d. Any given offset post may be configured as a plenum to convey HVAC, liquid, pneumatic, electrical power/data from a respective source to the mobile trellis 100a-d. While not shown in FIGS. 1A-D, an offset post 160b,d may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

A mobile trellis 100a-d may include a second web 180b,c (e.g., a web with a perimeter defining a circle, a web with a perimeter defining a circle having a 34″ diameter, a web with a perimeter defining a circle having a 36″ diameter, a web with a perimeter defining a circle having between a 15″ diameter and a 37″ diameter, a web with a perimeter defining a square, a web with a perimeter defining a rectangular, a web with a perimeter defining a triangle, etc.) removably supported on a plurality of vertical extension(s) 135b,d (e.g., four vertical extensions, three vertical extensions, more than four vertical extension, a single vertical extension, etc.).

A mobile trellis 100a-d may include a second weldment structure 170b-d (e.g., a weldment structure with a perimeter defining a circle, a weldment structure with a perimeter defining a circle having a 36″ diameter, a weldment structure with a perimeter defining a circle having a 37″ diameter, a weldment structure with a perimeter defining a circle having between an 15″ diameter and a 40″ diameter, a weldment structure with a perimeter defining a square, a weldment structure with a perimeter defining a rectangular, a weldment structure with a perimeter defining a triangle, etc.) removably supported on a plurality of vertical extension(s) 135b,d (e.g., four vertical extensions, three vertical extensions, more than four vertical extension, a single vertical extension, an 18″ vertical extension, a vertical extension between 10″ and 25″, etc.). The second weldment structure 170b-d may be configured to support a second web 180b,c (e.g., a web with a perimeter defining a circle, a web with a perimeter defining a circle having a 32″ diameter, a web with a perimeter defining a circle having a 36″ diameter, a web with a perimeter defining a circle having between a 20″ diameter and a 37″ diameter, a web with a perimeter defining a square, a web with a perimeter defining a rectangular, a web with a perimeter defining a triangle, etc.).

Any one of: the vertical extension 135b,d, the second weldment structure 170b-d, the second web 180b,c, a sub-combination thereof, or a combination thereof may be configured as a plenum to convey HVAC, liquid, pneumatic, electrical power/data from a respective source to the mobile trellis 100a-d. While not shown in FIGS. 1A-D, anyone of: a vertical extension 135b,d, the second weldment structure 170b-d, the second web 180b,c, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

A mobile trellis 100a-d may include a third web 180b-d (e.g., a web with a perimeter defining a circle, a web with a perimeter defining a circle having a 34″ diameter, a web with a perimeter defining a circle having a 36″ diameter, a web with a perimeter defining a circle having between a 15″ diameter and a 37″ diameter, a web with a perimeter defining a square, a web with a perimeter defining a rectangular, a web with a perimeter defining a triangle, etc.) removably supported on a plurality of vertical extension(s) 135b,d (e.g., four vertical extensions, three vertical extensions, more than four vertical extension, a single vertical extension, etc.).

The third web 180b-d may include a plurality of coaxial structures 181b, a plurality of tangentially extending structures 182b, and a plurality of web structures 183b. Any given coaxial structure 181b may include at least one of: a wire, a tube, a string, etc. Any given tangentially extending structure 182b may include at least one of: a wire, a tube, a string, etc. Any given web structure 183b may include at least one of: a wire, a tube, a string, etc.

Any one of: the vertical extension 135b,d, the third web 180b-d, the coaxial structure 181b, the tangentially extending structures 182b, the web structures 183b, a sub-combination thereof, or a combination thereof may be configured as a plenum to convey HVAC, liquid, pneumatic, electrical power/data from a respective source to the mobile trellis 100a-d. While not shown in FIGS. 1A-D, anyone of: the vertical extension 135b,d, the third web 180b-d, the coaxial structure 181b, the tangentially extending structures 182b, the web structures 183b, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

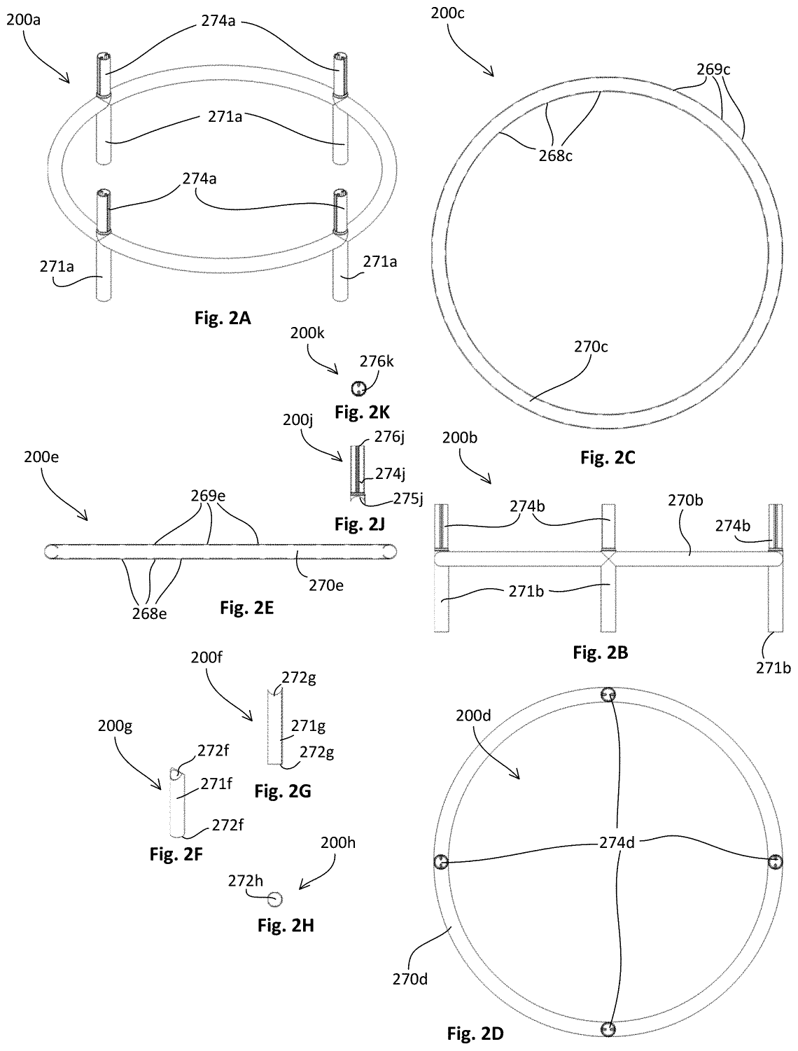

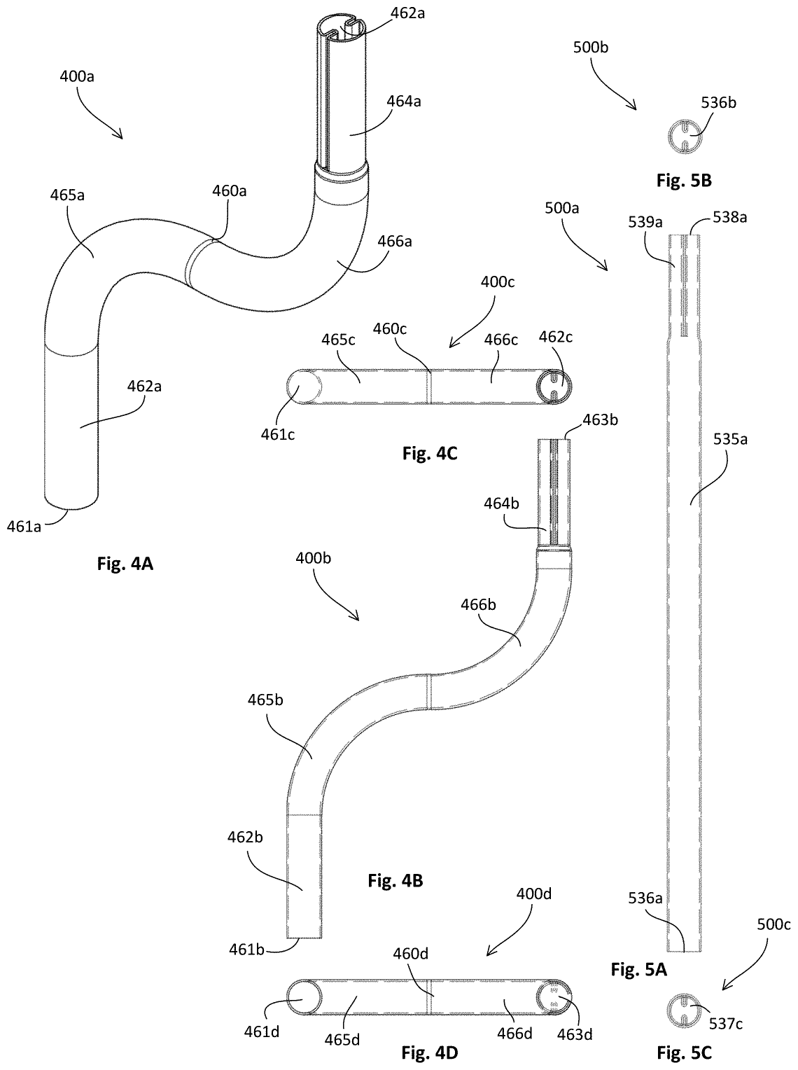

Turning to FIGS. 2A-H, J and K, a mobile trellis 200a-h,j,k may define, for example, a large diameter plenum structure having a weldment structure 270a-e (e.g., a weldment structure with a perimeter defining a circle, a weldment structure with a perimeter defining a circle having a 36″ diameter, a weldment structure with a perimeter defining a circle having a 37″ diameter, a weldment structure with a perimeter defining a circle having between an 15″ diameter and a 40″ diameter, a weldment structure with a perimeter defining a square, a weldment structure with a perimeter defining a rectangular, a weldment structure with a perimeter defining a triangle, etc.). The weldment structure 270a-e may include a plurality of receptacles 271a,b,g-h. Any given receptacle 271a,b,j-h may include a receptacle input 272g-h and a receptacle output 273g-h. The weldment structure 270a-e may include a plurality of posts 274a,b,d,j,k. Any given post 274a,b,d,j,k may include a post input 275j and a post output 276j,k. Any given receptacle 271a,b,g-h may be configured to removably receive a post 274a,b,d,j,k of another weldment structure 270a-e, a post (e.g., post 539 of FIG. 5A) of a vertical extension 135b,d/535a, or a post (e.g., post 464b of FIG. 4B) of an off-set 160b,d/460a-d.

Any given weldment structure 270a-e, receptacle 271a,b,g-h, post 274a,b,d,j,k, a sub-combination thereof, or a combination thereof may include at least one connection 269c,e (e.g., a quick connect fitting, a nipple, a waterproof electrical plug/socket, etc.), and/or at least one manually or automatically operated valve (not shown in FIGS. 2A-H, J and K), and/or at least one nozzle 268c,e (e.g., a liquid nozzle, a pneumatic nozzle, a fixed nozzle, a manually adjustable nozzle, an automatically adjustable nozzle, etc.).

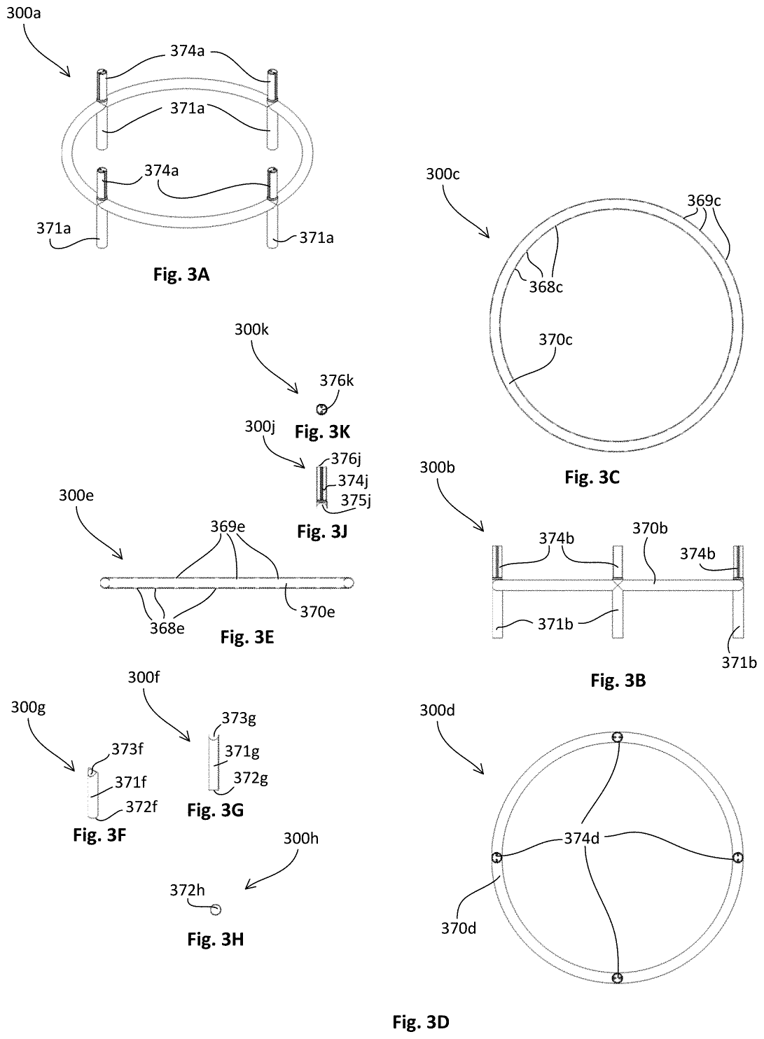

With reference to FIGS. 3A-H, J and K, a small diameter plenum structure having a weldment structure 370a-e (e.g., a weldment structure with a perimeter defining a circle, a weldment structure with a perimeter defining a circle having a 21″ diameter, a weldment structure with a perimeter defining a circle having a 25″ diameter, a weldment structure with a perimeter defining a circle having between an 11″ diameter and a 26″ diameter, a weldment structure with a perimeter defining a square, a weldment structure with a perimeter defining a rectangular, a weldment structure with a perimeter defining a triangle, etc.)

The weldment structure 370a-e may include a plurality of receptacles 371a,b,g-h. Any given receptacle 371a,b,j-h may include a receptacle input 372g-h and a receptacle output 373g-h. The weldment structure 370a-e may include a plurality of posts 374a,b,d,j,k. Any given post 374a,b,d,j,k may include a post input 375j and a post output 376j,k. Any given receptacle 371a,b,g-h may be configured to removably receive a post 374a,b,d,j,k of another weldment structure 370a-e, a post (e.g., post 539 of FIG. 5A) of a vertical extension 135b,d/535a, or a post (e.g., post 464b of FIG. 4B) of an off-set 160b,d/460a-d. Any given weldment structure 370a-e, receptacle 371a,b,g-h, post 374a,b,d,j,k, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

The weldment structure 370a-e may include a plurality of receptacles 371a,b,g-h. Any given receptacle 371a,b,j-h may include a receptacle input 372g-h and a receptacle output 373g-h. The weldment structure 370a-e may include a plurality of posts 374a,b,d,j,k. Any given post 374a,b,d,j,k may include a post input 375j and a post output 376j,k. Any given receptacle 371a,b,g-h may be configured to removably receive a post 374a,b,d,j,k of another weldment structure 370a-e, a post (e.g., post 539 of FIG. 5A) of a vertical extension 135b,d/535a, or a post (e.g., post 464b of FIG. 4B) of an off-set 160b,d/460a-d.

Any given weldment structure 370a-e, receptacle 371a,b,g-h, post 374a,b,d,j,k, a sub-combination thereof, or a combination thereof may include at least one connection 369c,e (e.g., a quick connect fitting, a nipple, a waterproof electrical plug/socket, etc.), and/or at least one manually or automatically operated valve (not shown in FIGS. 3A-H, J and K), and/or at least one nozzle 368c,e (e.g., a liquid nozzle, a pneumatic nozzle, a fixed nozzle, a manually adjustable nozzle, an automatically adjustable nozzle, etc.).

Turning to FIGS. 4A-D, an offset structure 400a-d may include a plurality of receptacles 471a-d. Any given receptacle 471a-d may include a receptacle input 472a-d and a receptacle output 473a-d. The offset structure 400a-d may include a plurality of posts 474a-d. Any given post 474a-d may include a post input 475a-d and a post output 476a-d. Any given receptacle 471a-d may be configured to removably receive a post 474a-d of another vertical extension 135b,d/535a, or a post (e.g., post 464b of FIG. 4B) of an off-set 160b,d/460a-d.

Any given offset structure 400a-d may be configured as a plenum to convey HVAC, liquid, pneumatic, electrical power/data from a respective source to the mobile trellis 100a-d. While not shown in FIGS. 4A-D, an offset post 400a-d may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

Any given offset structure 400a-d, receptacle 471a,b,g-h, post 474a,b,d,j,k, a sub-combination thereof, or a combination thereof may include at least one connection (e.g., a quick connect fitting, a nipple, a waterproof electrical plug/socket, etc.), and/or at least one manually or automatically operated valve, and/or at least one nozzle (e.g., a liquid nozzle, a pneumatic nozzle, a fixed nozzle, a manually adjustable nozzle, an automatically adjustable nozzle, etc.).

With reference to FIGS. 5A-C, an extension structure 500a-c a receptacle 571a-c. Any given receptacle 571a-c may include a receptacle input 537a-c and a receptacle output 538a-c. The extension structure 535a-c may include a plurality of posts 539a-c. Any given post 539a-c may include a post input 537c and a post output 536b. Any given receptacle 536a may be configured to removably receive a post 374a,b,d,j,k of a weldment structure 370a-e, a post (e.g., post 539 of FIG. 5A) of another vertical extension 135b,d/535a, or a post (e.g., post 464b of FIG. 4B) of an off-set 160b,d/460a-d.

Any given extension structure 500a-c, receptacle 536a, post 539a-c, a sub-combination combination thereof, or a combination thereof may include at least one connection (e.g., a quick connect fitting, a nipple, a waterproof electrical plug/socket, etc.), and/or at least one manually or automatically operated valve, and/or at least one nozzle (e.g., a liquid nozzle, a pneumatic nozzle, a fixed nozzle, a manually adjustable nozzle, an automatically adjustable nozzle, etc.).

Turning to FIG. 6, a large web structure 600 (e.g., a web with a perimeter defining a circle, a web with a perimeter defining a circle having a 34″ diameter, a web with a perimeter defining a circle having a 36″ diameter, a web with a perimeter defining a circle having between a 15″ diameter and a 37″ diameter, a web with a perimeter defining a square, a web with a perimeter defining a rectangular, a web with a perimeter defining a triangle, etc.) may include a plurality of coaxial structures 681, a plurality of tangentially extending structures 682, and a plurality of web structures 683. Any given coaxial structure 681 may include at least one of: a wire, a tube, a string, etc. Any given tangentially extending structure 682 may include at least one of: a wire, a tube, a string, etc. Any given web structure 683 may include at least one of: a wire, a tube, a string, etc.

Any one of: the coaxial structure 681, the tangentially extending structures 682, the web structures 683, a sub-combination thereof, or a combination thereof may be configured as a plenum to convey HVAC, liquid, pneumatic, electrical power/data from a respective source to the mobile trellis 100a-d. While not shown in FIG. 6, anyone of: the coaxial structure 681, the tangentially extending structures 682, the web structures 683, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

With reference to FIG. 7, a small web structure 700 (e.g., a web with a perimeter defining a circle, a web with a perimeter defining a circle having a 20″ diameter, a web with a perimeter defining a circle having a 24″ diameter, a web with a perimeter defining a circle having between a 10″ diameter and a 25″ diameter, a web with a perimeter defining a square, a web with a perimeter defining a rectangular, a web with a perimeter defining a triangle, etc.) may include a plurality of coaxial structures 781, a plurality of tangentially extending structures 782, and a plurality of web structures 783. Any given coaxial structure 781 may include at least one of: a wire, a tube, a string, etc. Any given tangentially extending structure 782 may include at least one of: a wire, a tube, a string, etc. Any given web structure 783 may include at least one of: a wire, a tube, a string, etc.

Any one of: the coaxial structure 781, the tangentially extending structures 782, the web structures 783, a sub-combination thereof, or a combination thereof may be configured as a plenum to convey HVAC, liquid, pneumatic, electrical power/data from a respective source to the mobile trellis 100a-d. While not shown in FIG. 7, anyone of: the coaxial structure 781, the tangentially extending structures 782, the web structures 783, a sub-combination thereof, or a combination thereof may include at least one connection (e.g., a quick connect fitting, a nipple, a waterproof electrical plug/socket, etc.), at least one manually or automatically operated valve, and/or at least one nozzle (e.g., a liquid nozzle, a pneumatic nozzle, a fixed nozzle, a manually adjustable nozzle, an automatically adjustable nozzle, etc.).

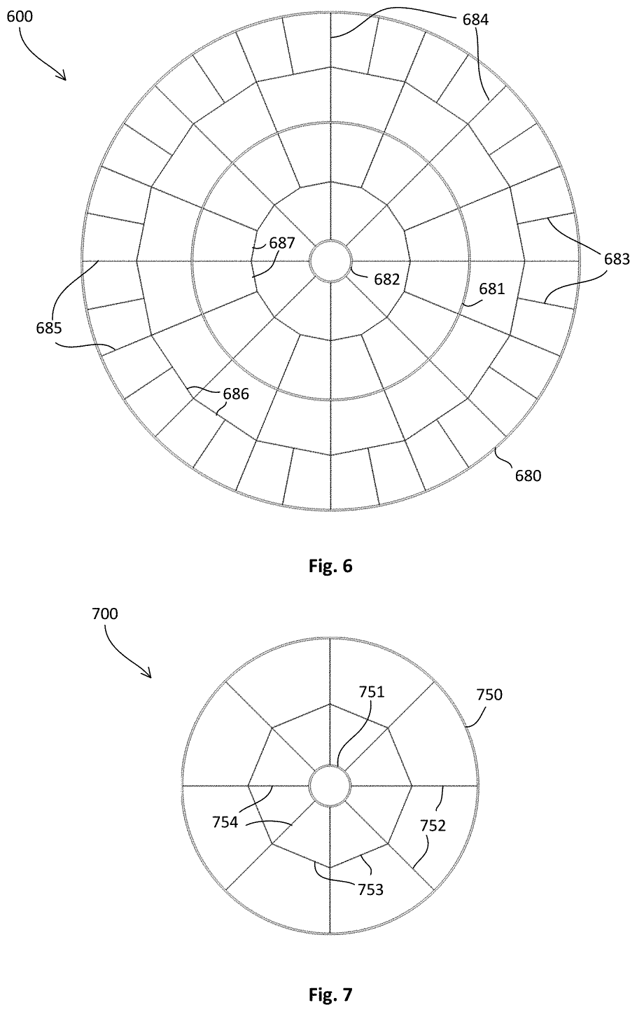

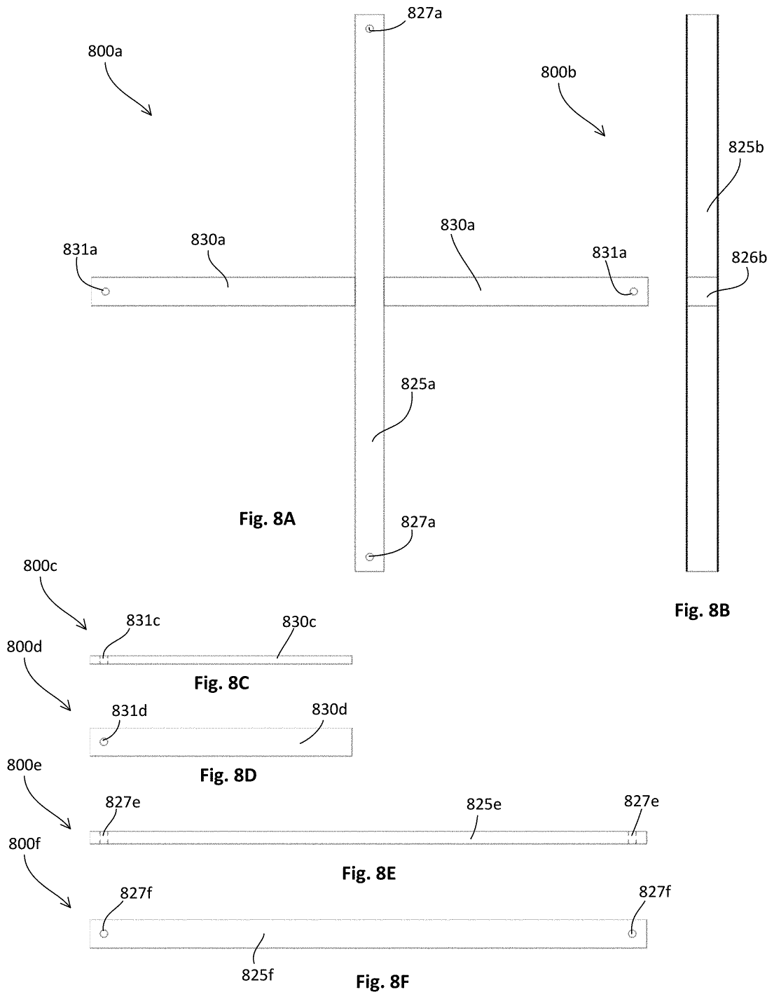

Turning to FIGS. 8A-F, a base structure 800a-f may include a long cross member 825a,b,e,f having a center aperture 828b and a first and second end aperture 827a,e,f near a respective end of the long cross member 825a,b,e,f, and configured to, for example, receive a post of a caster. The base structure 800a-f may include a pair of short cross members 830a,c,d having an aperture 831a,c,d near either end of the respective short cross member 830a,c,d.

While not shown in FIGS. 8A-F, a base structure 800a-f may include at least one rotary actuator and/or at least one linear actuator. An associated horticultural environment controller 1105 may control orientation of an associated plant relative some other three-dimensional reference via the at least one rotary actuator and/or the at least one linear actuator.

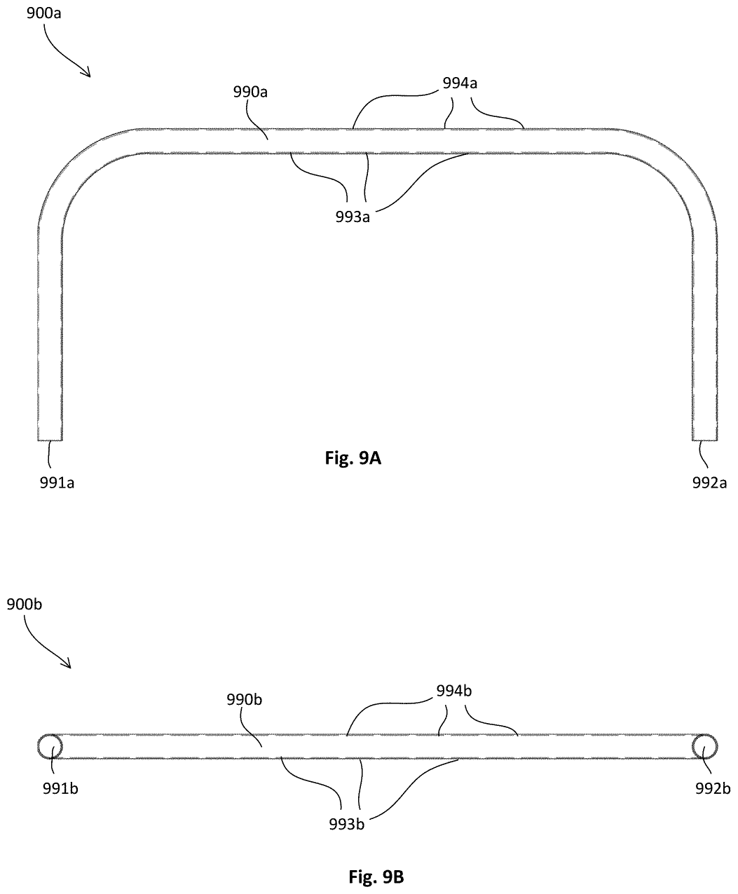

With reference to FIGS. 9A and 9B, a large lighting structure 900a,b having at least one first set of light sources 993a,b oriented in a first orientation and a second set of light sources 994a,b oriented in a second orientation. The large lighting structure 900a,b may include a receptacle 992a,b at either end. Any given receptacle 992a,b may be configured to, for example, receive a post 274a,b,j,k/374a,b,j,k/464a-c/539a.

While not shown in FIGS. 9A or 9B, a large lighting structure 900a,b may include at least one rotary actuator and/or at least one linear actuator. An associated horticultural environment controller may be configured to control at least one of the at least one rotary actuator and/or the at least one linear actuator to control a light emission angle relative to an associated plant(s). Alternatively, or additionally, the horticultural environment controller may be configured to control a predominant frequency (e.g., UV, Red, Green, Blue, etc.) of the first set of light sources 993a,b and/or the second set of light sources 994a,b. Similarly, the horticultural environment controller may be configured to control an intensity of the first set of light sources 993a,b and/or the second set of light sources 994a,b.

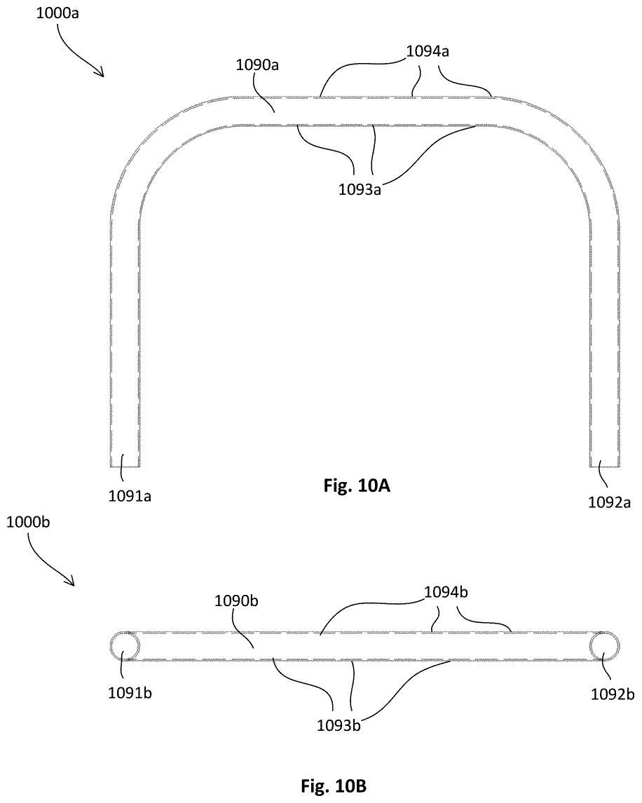

Turning to FIGS. 10A and 10B, a small lighting structure 1000a,b having at least one first set of light sources 1093a,b oriented in a first orientation and a second set of light sources 1094a,b oriented in a second orientation. The large lighting structure 1000a,b may include a receptacle 1092a,b at either end. Any given receptacle 1092a,b may be configured to, for example, receive a post 274a,b,j,k/374a,b,j,k/464a-c/539a.

While not shown in FIGS. 10A or 10B, a small lighting structure 1000a,b may include at least one rotary actuator and/or at least one linear actuator. An associated horticultural environment controller may be configured to control at least one of the at least one rotary actuator and/or the at least one linear actuator to control a light emission angle relative to an associated plant(s). Alternatively, or additionally, the horticultural environment controller may be configured to control a predominant frequency (e.g., UV, Red, Green, Blue, etc.) of the first set of light sources 1093a,b and/or the second set of light sources 1094a,b. Similarly, the horticultural environment controller may be configured to control an intensity of the first set of light sources 1093a,b and/or the second set of light sources 1094a,b.

With reference to FIG. 11, a horticultural environment 1100 may include an environment controller 1105. The environmental controller 1105 may include a processor 1106, a computer-readable memory 1107 having a module 1108 (e.g., a set of computer-readable instructions stored thereon, a set of registers, etc.), at least one user interface 1109 (e.g., a touch-screen display, etc.), and at least one communication interface 1110. The processor 1106 may execute the computer-readable instructions 1108 to, for example, cause the processor 1106 to generate at least one output (e.g., at least one output 1125-1130) based upon at least one input (e.g., at least one input 1112-1122).

The environment controller 1105 may include, for example, at least one light sensor 1112 (e.g., a plant light intensity sensor, a horticultural environment light intensity sensor, a plant light frequency sensor, a horticultural environment light frequency sensor, etc.), at least one liquid flow sensor 1113 (e.g., a water flow meter, a fertilizer flow meter, a pesticide flow meter, etc.), a horticultural environment carbon dioxide sensor 1114, a horticultural environment carbon monoxide sensor 1115, at least one horticultural environment oxygen sensor 1116, at least one horticultural environment humidity sensor 1117, a year/date/time input 1118, a horticultural environment temperature sensor 1119, a horticultural environment access door open/close sensor 1120, at least one camera input 1121, at least one pH sensor 1122, any sub-combination thereof, or a combination thereof.

The environment controller 1105 may include one or more actuator outputs 1125 (e.g., a valve output, a relay output, a switch output, a warning annunciator output, a solenoid output, a linear actuator output, a rotary actuator output, etc.), at least one plant grow light output 1126, at least one horticultural environment light output 1127, at least one linear actuator output 1128, at least one rotary actuator output 1129, at least one horticultural environment warning output 1130, any sub-combination thereof, or a combination thereof.

The environment controller 1105 may include a horticultural environment heating, ventilating, and air conditioning (HVAC) system interface 1135 (e.g., a horticultural environment fan, a plant fan, a horticultural environment heater, a plant heater, a horticultural environment air conditioning, a plant air conditioner, etc.), a liquid system interface 1140 (e.g., a water system, a fertilizer system, a pesticide system, etc.), a pneumatic system 1145 (e.g., a carbon dioxide (CO₂) system, a carbon monoxide (CO) system, an oxygen system, a pesticide system, etc.), an electric power/data system 1150, any sub-combination thereof, or a combination thereof.

The environment controller 1105 may include a remote horticultural environmental monitoring and security system 1155 interface 1111. The processor 1106 may execute the module 1108 to, for example, cause the processor 1106 to perform horticultural environment data gathering, storage and/or analysis (e.g., total cycle time for typical plant maturity, horticultural environment daily cost of operation, horticultural environment warning record data, etc.).

The processor 1106 may execute the module 1108 to, for example, cause the processor 1106 to generate a rotary actuator output 1129 (e.g., a center power drive configured to turn an entire plant while, for example, the plant is within a trellis (e.g., mobile trellis 101a of FIG. 1A) and under lights (e.g., lights 993a,b/994a,b/1093a,b/1094a,b. Thereby, the environmental controller 1105 may automatically rotate a plant relative any given light to, for example, have the plant get more broadly distributed light exposure to more parts of an associated plant canopy.

A rotary actuator may include an electric drive to a center spindle. The processor 1106 may execute the module 1108 to, for example, cause the processor 1106 to generate a rotary actuator output 1129 to rotate a plant relative to a light emitter, a pneumatic flow, a liquid flow, etc. Alternatively, or additionally, the processor 1106 may execute the module 1108 to, for example, cause the processor 1106 to generate a rotary actuator output 1129 to rotate a light emitter, a pneumatic flow, a liquid flow, etc. relative to the plant.

A mobile trellis 101a may include robot driven casters 105b, 110b,d, 115b,d, 120b,d. The processor 1106 may execute the module 1108 to, for example, cause the processor 1106 to generate a caster drive output to perform a motor driven mass-trellis relocate (e.g., move an entire row of trellises in response to a single pushbutton, automatically move an array of trellises based on a predetermined reorientation schedule, etc.).

The processor 1106 may execute the module 1108 to, for example cause the processor 1106 anticipate changes in an associated horticultural environment based upon an event (e.g., a door opening, a component failure, etc.). The processor 1106 may preemptively alter an “input” to, and/or an “output” from, a horticultural environment based on anticipating a change in the horticultural environment.

As a particular example, historical data related to past operation of a horticultural environment may indicative that a temperature inside the horticultural environment will drop any time an associated door is open. Accordingly, the processor 1106 may execute the module 1108 to, for example, cause the processor to generate a horticultural environment heater whenever a door switch input indicates that the door has been open. Anticipatory (proactive) functionality may be more granular. For example, the decision whether to turn on heat may be further based on a day of a year and/or a time of day. Additionally, or alternatively, the decision whether to turn on heat may be further based on an ambient temperature outside the horticultural environment.

The processor 1106 may execute the module 1108 to, for example, cause the processor 1106 to generate a model horticultural environment using historical horticultural environment operation data along with at least one input (e.g., manual input related to success of plant growth, automatic plant weight data, etc.) that indicates a set of historical data related to a successful plant growth batch cycle. In any event, the processor 1106 may periodically correlate inputs to a horticultural environmental controller 1105 and/or outputs from the horticultural environmental controller 1105, and store the horticultural environment operation data in the memory 1107.

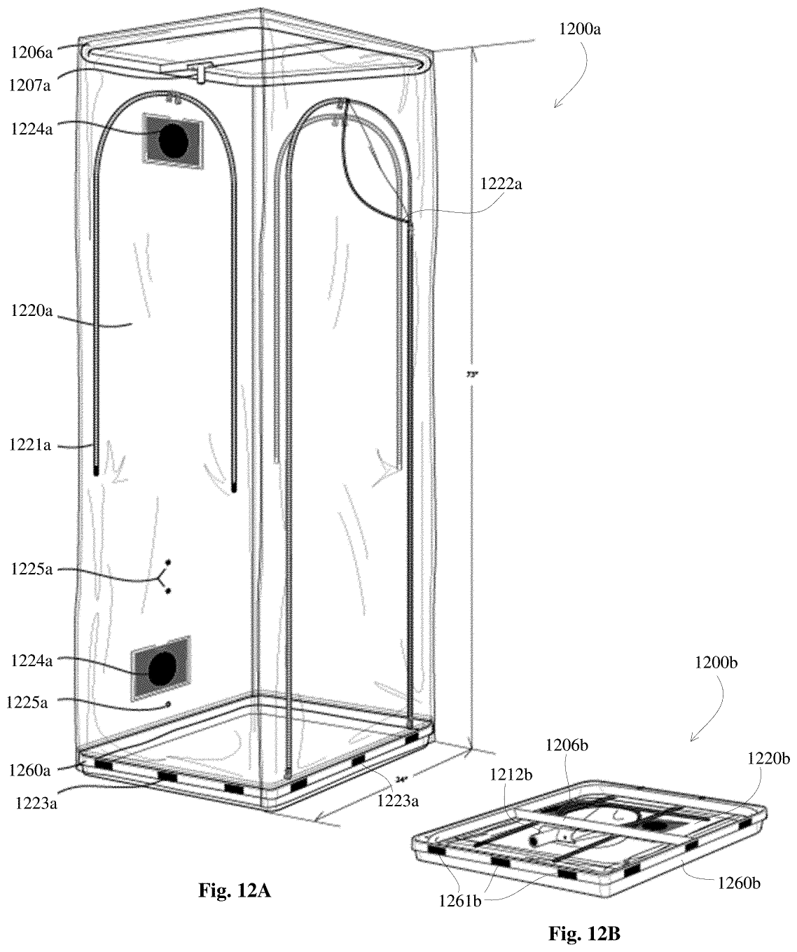

With reference to FIGS. 12A and 12B, a micro-climate 1200a,b may be provided within an enclosure 1220a,b for use with a mobile trellis 1206a,b/1207a/1212b. As shown in FIG. 12B, the enclosure 1220a,b and the mobile trellis 1206a,b/1207a/1212b may be configured to fold up and fit, at least partially, within a drip pan 1260a,b. The enclosure 1220a,b may include first attachments (e.g., Velcro®) 1223a configured to engage second attachments (e.g., Velcro®) 1261b to secure the enclosure 1220a,b to the drip pan 1260a,b. The enclosure 1220a,b may include, for example, zipper openings 1221a, 1222a, air openings 1224a, and snaps 1225a. The snaps 1225a may be configured to engage with, for example, deodorizing filters (not shown in FIGS. 12A and 12B) to cover at least one air opening 1224a. In any event, a micro-climate 1200a,b may include any one of, any sub-combination of, any combination of, or all of the functionality as described herein with regard to a micro-climate proximate an associated plant or plants. For example, an enclosure 1220a,b may be incorporated into a mobile trellis 101a such that at least one plant is contained within the enclosure 1220a,b. An enclosure 1220a,b drip pan 1260a,b may be supported on, for example, a reorientable structure (e.g., long cross-member 125b,c, two short cross-members 130b-d, a first caster 105b with position-lock 106b, a second caster 110b,d, a third caster 115b,d with lock 116b, and a fourth caster 120b,d of FIG. 2B).

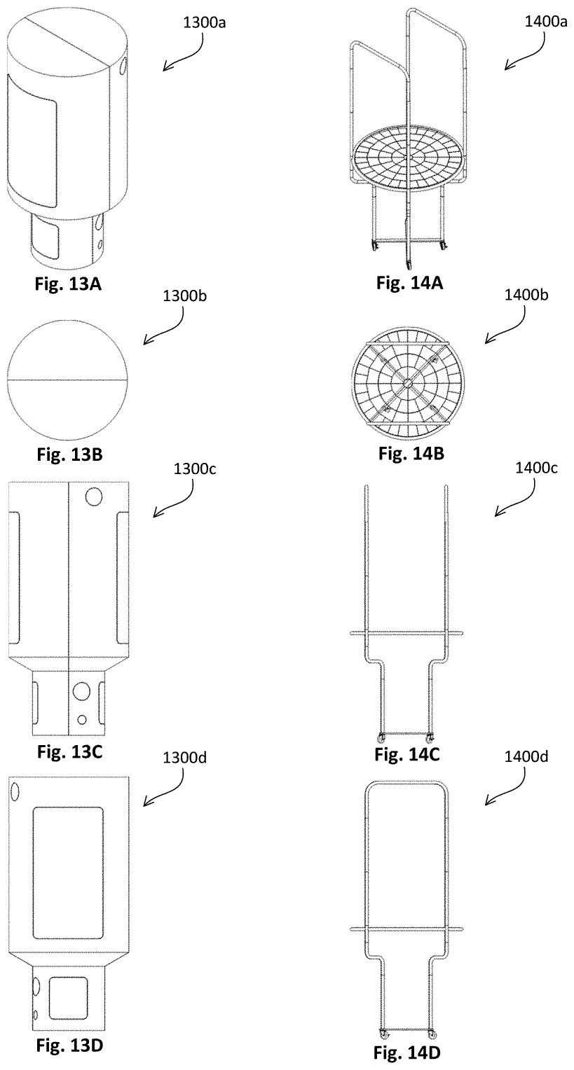

Turning to FIGS. 13A-D, an enclosure for a micro-climate 1300a-d may be configured to, for example, at least partially enclose a single mobile trellis (e.g., a mobile trellis 1400a-d of FIGS. 14A-D, etc.). The enclosure for a micro-climate 1300a-d may be similar to, for example, the enclosure 1200a,b. The enclosure 1300a-d may, for example, include a flexible fabric and a reflective interior lining. Thereby, a light (not shown in FIGS. 13A-D) may be, for example, positioned above a plant within the enclosure 1300a-d and photons emitted from the light may reflect from the reflective interior lining toward an interior of the enclosure 1300a-d.

With reference to FIGS. 14A-D, a mobile trellis 1400a-d may be similar to, for example, any one of the mobile trellis 100a-d. A mobile trellis 1400a-d may, for example, include two diameters: 24″ and 36″ and may define a ready to assemble kit. Assembly of the mobile trellis 1400a-d may start by, for example placing four casters into a steel base. Four lower extension tubes may then be, for example, threaded onto a respective caster bolt and hand tightened. A web ring may then be, for example, installed onto a respective extension tube. A web ring may be seated onto the tubes by, for example, tapping the web ring into place with a rubber mallet. Extension tubes with black top-caps may then be, for example, installed onto the web ring. With the extension tubes in place, attach a 24″ steel Webb to the web ring using, for example, Velcro wraps that may be, for example, included in the kit. A second stage steel webb may then attached to the extension tubes with, for example, Velcro wraps and height adjusted as desired. Alternatively, the 24 Inch Webb can also be built with an

optional Light Bar Extension Kit for installing grow lights. As another option, a 36-inch version of the Webb may use a similar base as the 24-inch Webb, but adds expansion arms to support the larger web ring. Once the webb ring is in place, either the extension arms or an optional light bar extension kit may be installed.

An optional 24 inch steel webb can be installed as a first stage to the lower webb ring. The first 36-inch steel webb may rest on the expansion arms and may be held in place with, for example, Velcro wraps. The second 36 inch webb may be attached to the extension tubes and may be height adjusted as desired. A mobile trellis may be easily configured for different growing styles and spaces.

Although exemplary embodiments of the invention have been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A mobile plant micro-climate system, the system comprising:
a trellis having a trellis relocation mechanism, wherein the trellis relocation mechanism includes at least three casters;
an enclosure, wherein the enclosure is supported by the trellis; and
an environmental controller configured to control an environment of an interior of the enclosure independent from an environment outside the enclosure, wherein the environmental controller includes a first interior environment sensor input, a first exterior environment sensor input, an enclosure access open indication input, and a first interior environment control output, and wherein the environmental control is configured to alter the first interior environment control output based on the enclosure access open indication input irrespective of a status of the first interior environment sensor input or the first exterior environment sensor.

2. The system of claim 1, wherein the trellis includes expandable and/or reusable components, wherein at least one of the components is used with a second plant following use of the trellis and/or trellis component with a first plant.

2. The system of claim 1 incorporated into a horticultural environment.

3. The system of claim 1, wherein the trellis includes modular components.

4. The system of claim 1, wherein the environmental controller is configured to create a microclimate for an associated plant within the enclosure.

5. The system of claim 1, wherein the environmental controller is configured to anticipate changes in an associated horticultural environment within the enclosure based upon an event.

6. The system as in claim 5, wherein the event includes at least one of: a change in temperature within the enclosure, a change in humidity within the enclosure, a change in oxygen within the enclosure, a change in carbon monoxide within the enclosure, and a light level within the enclosure.

7. The system of claim 1, wherein the environmental controller is configured to preemptively alter the first interior environment control output based on anticipating a change in a horticultural environment within the enclosure.

8. A mobile plant micro-climate system, the system comprising:
a trellis having a trellis relocation mechanism;
an enclosure, wherein the enclosure is supported by the trellis; and
an environmental controller configured to control an environment of an interior of the enclosure independent from an environment outside the enclosure, wherein the environmental controller includes a first interior environment sensor input, an enclosure access open indication input, and a first interior environment control output, and wherein the environmental control is configured to alter the first interior environment control output based on the enclosure access open indication input irrespective of a status of the first interior environment sensor input.

9. The system of claim 8, wherein the enclosure access open indication input is representative of an interior pressure.

10. The system of claim 8, wherein the first interior environmental control input is representative of at least one of: a temperature within the enclosure, humidity within the enclosure, oxygen within the enclosure, carbon monoxide within the enclosure, or a light level within the enclosure.

11. The system of claim 8, wherein the environmental controller is configured to create a microclimate for an associated plant within the enclosure.

12. The system of claim 8, wherein the environmental controller is configured to anticipate changes in an associated horticultural environment within the enclosure based upon an event.

13. A system as in claim 12, wherein the event includes at least one of: a change in temperature within the enclosure, a change in humidity within the enclosure, a change in oxygen within the enclosure, a change in carbon monoxide within the enclosure, and a light level within the enclosure.

14. The system of claim 8, wherein the environmental controller is configured to preemptively alter the first interior environment control output based on anticipating a change in a horticultural environment within the enclosure.

15. A mobile plant micro-climate system, the system comprising:
a trellis having a trellis relocation mechanism;
an enclosure, wherein the enclosure is supported by the trellis; and
an environmental control input configured to control an environment of an interior of the enclosure independent from an environment outside the enclosure, wherein the environmental control input is configured to alter an environment inside the enclosure based on an enclosure access open indication input irrespective of a status of the interior environment of the enclosure.

16. The system of claim 15, wherein the enclosure access open indication input is representative of an interior pressure.

17. The system of claim 15, wherein the first interior environmental control input is representative of at least one of: a temperature within the enclosure, humidity within the enclosure, oxygen within the enclosure, carbon monoxide within the enclosure, or a light level within the enclosure.

18. The system of claim 15, wherein an environmental controller is configured to anticipate changes in an associated horticultural environment within the enclosure based upon an event.

19. A system as in claim 18, wherein the event includes at least one of: a change in temperature within the enclosure, a change in humidity within the enclosure, a change in oxygen within the enclosure, a change in carbon monoxide within the enclosure, and a light level within the enclosure.

20. The system of claim 15, wherein an environmental controller is configured to preemptively alter the first interior environment control output based on anticipating a change in a horticultural environment within the enclosure.
